(19) United States
(12) Patent Application Publication
(10) Pub. No.: US 2026/0056144 A1
(43) Pub. Date: Feb. 26, 2026

(54) SHREDDER SCANNER

(71) Applicant: Industrial Service Solutions, Houston, TX (US)

(72) Inventors: Jack Hodges, Houston, TX (US); William Tigner, Houston, TX (US)

(73) Assignee: Industrial Service Solutions, Houston, TX (US)

(21) Appl. No.: 18/809,609

(22) Filed: Aug. 20, 2024

(51) Int. Cl. G01N 23/10; B02C 23/02; G01N 23/04; G01N 23/083; G06V 10/70; G06V 20/50; G06V 20/60

(52) U.S. Cl. CPC G01N 23/10; B02C 23/02; G01N 23/04; G01N 23/083; G06V 10/70; G06V 20/50; G06V 20/60; G01N 2223/3307; G06V 2201/06

(57) ABSTRACT

A system may include a shredder and a conveyor to transport a shred object to the shredder. The system may include a scanner upstream of the shredder to generate an image of the shred object on the conveyor. The system may include an image parser to generate an indication of a portion of the shred object as unfit for shredding by parsing the image of the shred object based on an identifier model trained on a sample training data set. The system may include a controller in communication with: the image parser to receive the indication from the image parser; and at least one of the shredder, the conveyor, or a removal tool to provide, in response to the indication of the unfit portion of the shred object, an operational command to reduce a likelihood that the unfit portion of the shred object is processed by the shredder.

### BACKGROUND

Shredding is a process by which materials are broken down to facilitate disposal, volume reduction, protection of confidential or proprietary information, protected information, or intellectual property, for pre-processing for recycling or manufacturing, and the like. Shredders can be purpose built to process certain materials or ranges of materials, render a corresponding particulate size, and/or a processing speed/rate.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a perspective view of a system, according to one or more examples of the disclosure.

FIG. 2 is a perspective view of another embodiment of the system of FIG. 1, according to one or more examples of the disclosure.

FIG. 3 is a cross-sectional view of the scanner of FIG. 1, according to one or more examples of the disclosure.

FIG. 4 is a block diagram of an apparatus for controlling a shredding process, according to one or more examples of the disclosure.

FIG. 5 is a block diagram of a controller, according to one or more examples of the disclosure.

FIG. 6 is a flowchart depicting a method for controlling a shredding process, according to one or more examples of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

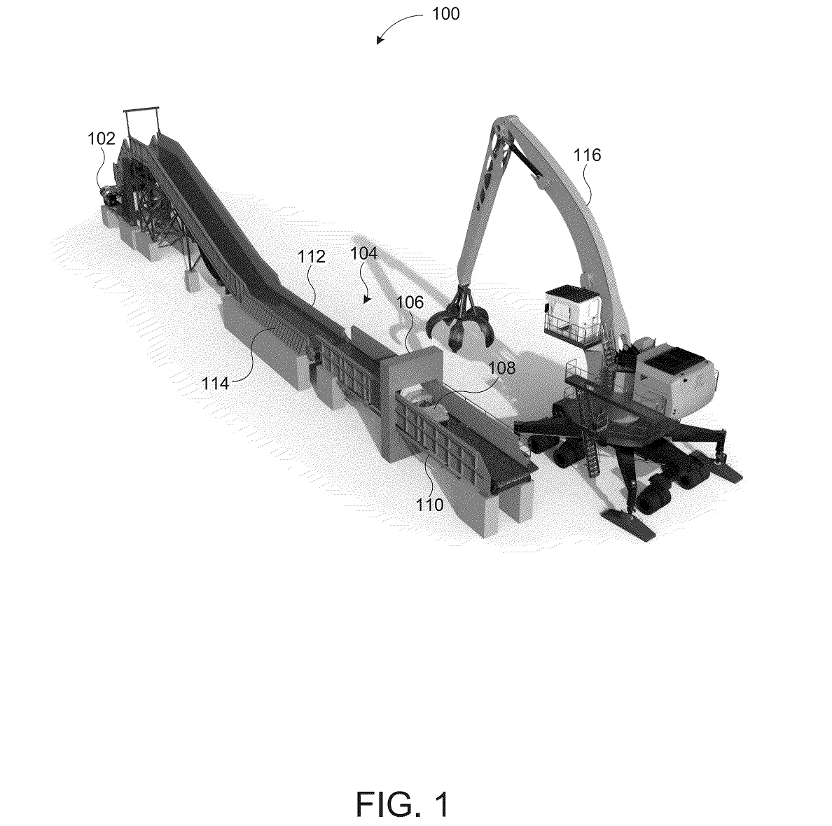

FIG. 1 is a perspective view of a system 100, according to one or more examples of the disclosure. In some examples, the system 100 includes a shredder 102, a conveyor 104, and a scanner 106. The shredder 102 may be a shredder configured to break down materials or objects, such as a shred object 108 through the application of physical force. Other applications using other breakdown methods such as laser, chemical, or the like are also contemplated through the exemplary term of “shredder” is used herein. Thus, the terms “shredder” and “shred” as used herein encompass not only the act of shredding and an apparatus used therefor, but also acts that break down objects like lasers, chemicals (e.g., chemical baths), etc. The shredder 102 may be provided materials or shred objects 108 by the conveyor 104.

The conveyor 104 may be positioned relative to the shredder 102 to transport the shred object 108 to the shredder 102. The conveyor 104 may be capable of handling the movement of shred objects of different weights, sizes, and shapes. The conveyor 104 may provide an efficient and safe handling of the shred object 108. In some examples, the conveyor 104 may be an automotive conveyor to convey an automobile or similar shred object 108 to the shredder 102. The conveyor 104 may use a conveyor belt, roller set, container trolley, or the like to transport a material and/or object. The conveyor 104 may be linearly arranged to transport the shred object 108 along a linear path. The conveyor 104 may be, at least partially, non-linear to transport the shred object 108 along a non-linear path. The conveyor 104 may be non-linear in one or more dimensions. For example, as shown in FIG. 1, the conveyor 104 may carry the shred object 108 through a change in elevation.

The scanner 106 may be positioned upstream of the shredder 102 relative to the conveyor 104 to generate an image of the shred object 108 as the shred object 108 is moved proximate the scanner 106 and prior to the shred object 108 being introduced into the shredder 102. In some embodiments, the scanner 106 may generate an image by directing x-ray energy to the shred object 108 and detecting the x-ray energy passed through the shred object 108. While examples discussed herein may refer to x-ray energy, other types of inspection may be used (e.g., optical, magnetic, sonic, etc.) furthermore, different energy levels, frequencies, bandwidths, wavelengths, etc. may be used for inspection of the shred object 108. The x-ray energy may be directed, by the scanner 106, towards the shred object 108 on the conveyor 104.

The x-ray energy may be emitted in a pattern. For example, the x-ray energy may be emitted in a collimated or non-collimated pattern. In some embodiments, the x-ray energy is emitted in a pattern or energy level corresponding to the shred object 108. For example, a size, shape, density, or other characteristic of the shred object 108 may be detected (e.g., via optical, weight, or other inspection) or manually provided and used to determine an x-ray pattern emitted by the scanner 106. The x-ray emission pattern may be at any angle or range of angles relative to the shred object 108 and/or the conveyor 104. Similarly, the angle and/or range of angle of emission of the x-ray energy may be manually or automatically adjusted based on the shred object 108, conveyor speed, etc.

The scanner 106 may generate an image of the shred object 108. The image may be a digital image or otherwise. In some embodiments, the image of the shred object 108 is generated by detecting energy passed and/or backscattered (or otherwise passed, deflected, and/or reflected) by the shred object 108. In some embodiments, the scanner 106 includes a detection component positioned to receive the energy from the shred object 108. For example, an x-ray detector or equivalent may be positioned to receive energy from the shred object 108 to produce data usable to generate an image of the shred object 108. One or more detectors may be used to detect the same or different types or vectors of energy from the shred object 108. The one or more detectors may be tuned to detect one or more wavelengths, or a bandwidth, of energies expected to be detected. In some embodiments, the one or more detectors may be tuned to detect energy emitted by the shred object 108. For example, the shred object 108 may be radioactive or may be reactive to x-ray or other energy emitted to the shred object 108. The one or more detectors may be tuned to be sensitive to energy from the shred object to determine a nature or characteristic of the shred object 108 as fit or unfit for shredding.

The conveyor 104 may include a scan conveyor portion 110 corresponding to the scanner 106. In some embodiments, scan conveyor portion 110 conveys the shred object 108 relative to the scanner 106. The scan conveyor portion 110 may provide a conveyance speed corresponding to a scanning operation performed by the scanner 108. For example, the scan conveyor portion 110 may provide a conveyance speed different from another portion of the conveyor 104 to facilitate generation of the image of the shred object 108 or for generation of a second imaging of the shred object 108 by providing a second pass of the shred object 108 relative to the scanner 106. This may be performed in response to a manual command or an automated determination. For example, an image may reveal a component of the shred object 108 which is questionable or results in a low confidence level of identification. This may satisfy one or more criteria for a second scan to improve the confidence level of the imaging or to allow for a second imaging after a repositioning or rearrangement of the shred object 108 to provide a different angle, view, resolution, or other scan type or process for the imaging of the shred object 108 by the scanner 106.

In some embodiments, the conveyor 104 includes a shred conveyor portion 112 corresponding to the shredder 102 to convey the shred object 108 to the shredder independent of the scan conveyor portion 110 of the conveyor 104. In some embodiments, the shred conveyor portion 112 is positioned to receive the shred object 108 from the scan conveyor portion 110. In some embodiments, at least one of the shred conveyor portion 112 and/or the scan conveyor portion 110 is adjustable in elevation to facilitate relative positioning of the scan conveyor portion 110 and the shred conveyor portion 112 to pass the shred object between the scan conveyor portion 110 and the shred conveyor portion 112.

In some embodiments, the conveyor 104 is at least partially bounded by an optional retaining structure 114. The retaining structure 114 may be a wall, rail, basket, bucket, net, or other structure to provide a physical barrier along at least a portion of the conveyor 104. The retaining structure 114 may reduce a chance of the shred object 108 falling from the conveyor 104. In some embodiments, the retaining structure 114 may be repositionable relative to the conveyor 104 to allow for passage of a shred object 108 along the conveyor 104 and/or for removal of the shred object 108 from the conveyor 104. For example, if a shred object 108 is determined to include a portion unfit for shredding, the retaining structure 114 may be manually or automatically repositioned to allow for removal of at least the unfit portion of the shred object 108 from the conveyor 104.

In some embodiments, the retaining structure 114 may include a removal tool (not shown) such as a moveable portion of the retaining structure 114 which may be actuated to remove at least the unfit portion of the shred object 108 from the conveyor 104. For example, the retaining structure 114 may include a pusher or other component to remove at least the unfit portion of the shred object 108 from the conveyor 104. In other embodiments, the retaining structure 114 may be sized or moveable to facilitate engagement of a removal tool (e.g., end-effector 116 of FIG. 1) with at least the unfit portion of the shred object 108, while on the conveyor 104, to remove at least the unfit portion of the shred object 108 from the conveyor 104.

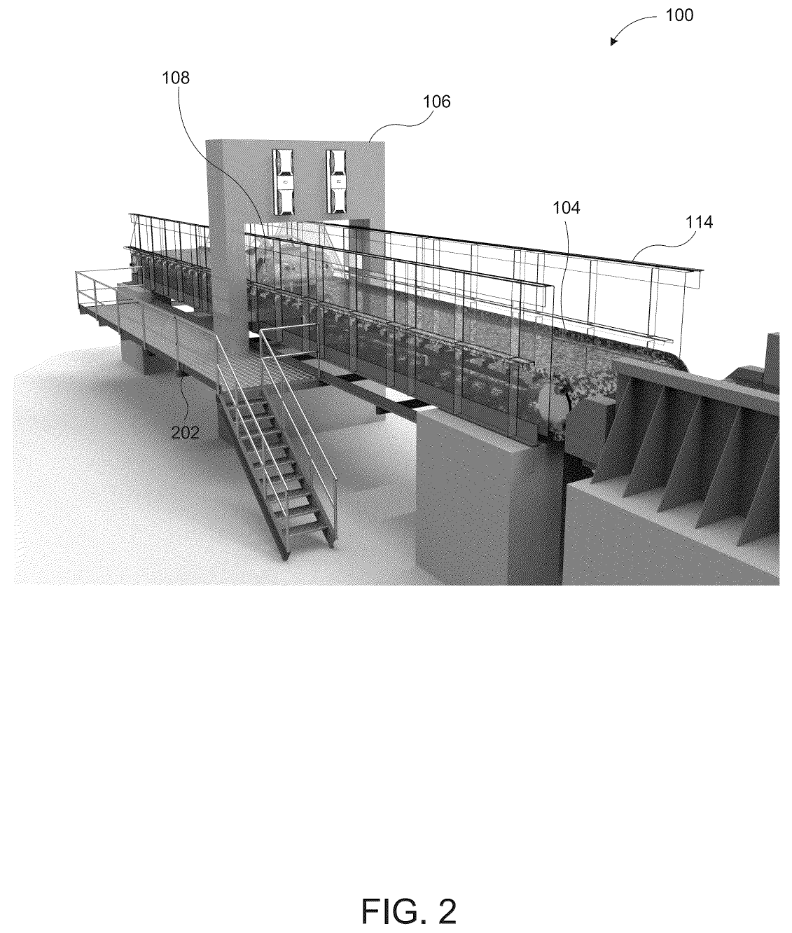

FIG. 2 is a perspective view of another embodiment of the system 100 of FIG. 1, according to one or more examples of the disclosure. The system 100 may include a retaining structure 114 to retain the shred object 108 on the conveyor 104. The retaining structure 114 may allow for viewing of the shred object 108 on the conveyor 104. For example, a viewing port or other aperture or transparent portion (not shown) may allow for visual inspection of the shred object 108 through the retaining structure 114.

In some embodiments, the retaining structure 114 may provide shielding to prevent energy from the scanner 106 from reaching beyond the retaining structure 114. Shielding may be provided where an operator or other worker or bystander and/or sensitive system may be otherwise exposed to energy from the scanner 106. For example, in the illustrated embodiment, a platform 202 is shown. In some examples, shielding may be provided proximate the platform 202 to reduce energy emissions from the scanner 106 reaching the platform 202.

In some embodiments, the retaining structure 114 may include an optional access mechanism (not shown) such as a door, hatch, port, gap, diverter, or the like, to allow for access to, or removal of, the shred object 108 from the conveyor 104. The access mechanism may allow for removal and/or further inspection of the shred object 108. For example, if a portion of the shred object 108 is determined to be potentially unfit for shredding, the unfit portion may be positioned, by the conveyor 104, to be at or near the access mechanism such that the unfit portion may be visually inspected and/or removed from the conveyor 104. In some embodiments, the access mechanism may be a gap or wider positioning of the retaining structure 114 to allow a removal tool to access and engage at least the unfit portion for removal from the conveyor 104. In another example, the conveyor 104 may include a diverting mechanism to remove the unfit portion to a second conveyor, a receptacle, etc.

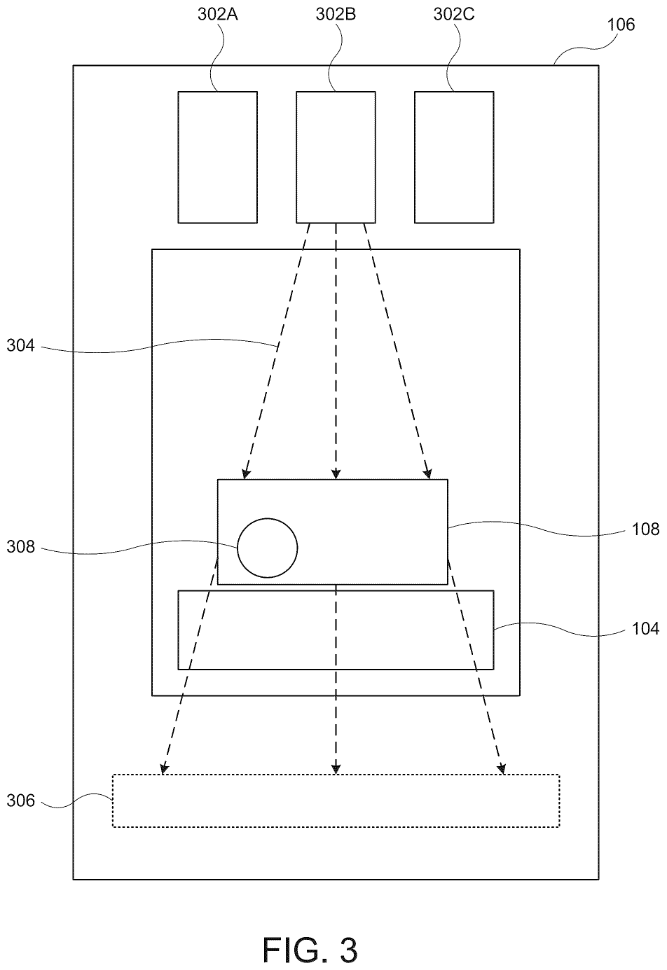

FIG. 3 is a cross-sectional view of the scanner 106 of FIG. 1, according to one or more examples of the disclosure. The scanner 106 may include one or more emitters 302 A-C to emit energy to the shred object 108. The emitters 302 may also include a camera or other sensor for gathering energy from the shred object 108. The emitters 302 may operate separately or together. For example, a first emitter 302A may emit energy 304 towards the shred object 108 having a type, pattern, intensity, or other characteristic corresponding to a trigger (e.g., a shred object size characteristic, weight characteristic, or the like). In some embodiments, one or more of the emitters 302 A-C may be different from another of the emitters 302 A-C. For example, one or more of the emitters 302 A-C may have a power level higher than another of the emitters 302 A-C. One or more of the emitters 302 A-C may have an emission pattern different from another of the emitters 302 A-C. One of more of the emitters 302 A-C may emit energy 304 in a different wavelength, frequency, or the like, from another of the emitters 302 A-C. In the illustrated example, the emitters 302 A-C are shown in a certain orientation relative to one another, another component of the scanner 106, the conveyor 104, and/or the shred object 108. In other embodiments, the emitters 302 A-C may be positioned at different locations and/or orientations on/in the scanner 106. For example, one or more of the emitters 302 A-C may be positioned to provide the energy 304 to the shred object 108 to provide a side view of the shred object 108 while another of the emitters 302 A-C is positioned to provide the energy 304 to the shred object 108 to provide a top view of the shred object 108. Other arrangements and/or orientations of the one or more emitters 302 A-C may be used. One or more detectors 306 corresponding to the one or more emitters 302 A-C may be positioned and/or oriented accordingly.

The scanner 106 may include one or more detectors 306. The detector 306 may correspond to and/or be positioned relative to one or more emitters 302 A-C. The detector 306 may detect the energy 304 provided by one or more of the emitters 302 A-C. For example, the detector 306 may be an x-ray detector positioned to receive x-ray energy from a least one x-ray emitter. In some embodiments, the detector 306 is fixed in position and/or orientation. In other embodiments, the detector 306 is adjustable in relative position and/or orientation. The detector 306 may be repositionable and/or reorientable in response to a characteristic of the shred object 108 or other metric (e.g., energy level of the emitters 302 A-C, pattern of the emitters 302 A-C, transport rate of the conveyor 104, etc.). In some embodiments, at least one of the emitter 302 and/or the detector 306 may be repositionable and/or reorientable to adjust a clarity of an image of at least a portion 308 of the shred object 108 that may be assessed for fitness for shredding. The unfit portion 308 may be in a position within the shred object 108 that is better imaged by an adjusted position and/or orientation of the detector 306 and/or at least one of the emitters 302 A-C. The emitters 302 A-C and or detector 306 may be adjusted to provide or detect energy conducive to imaging of the potential unfit portion 308.

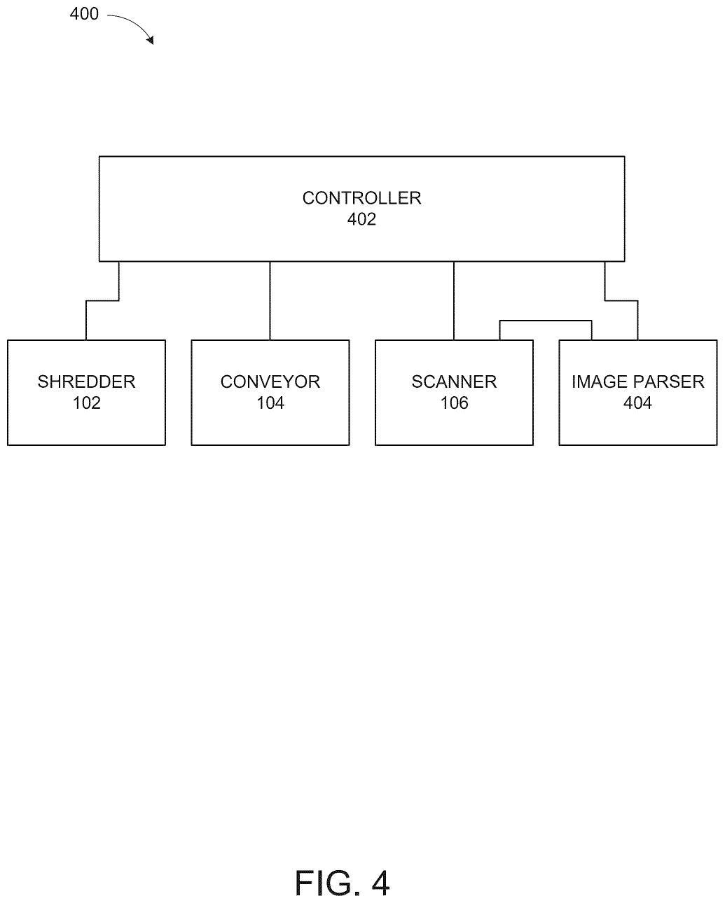

FIG. 4 is a block diagram of an apparatus 400 for controlling a shredding process, according to one or more examples of the disclosure. The apparatus 400 may include a controller 402. The controller 402 may be local to at least one of the scanner 106 and/or shredder 102. In some examples, the controller 402 is remote relative to at least one of the scanner 106 and/or the shredder 102. The controller 402 may be a general purpose device or application-specific device. The controller 402 may be implemented in hardware, software, or a combination of hardware and software.

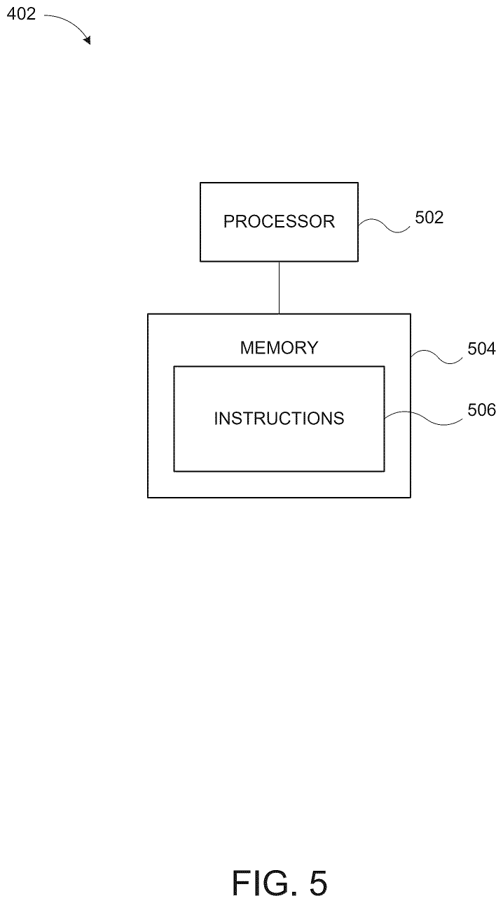

FIG. 5 is a block diagram of a controller, according to one or more examples of the disclosure. The controller 402 may be a processor-built resource built around one or more processors 502 and a memory 504. The one or more processors 502 may be used for controlling the general operations of the controller 402, as well as handling and/or processing of the image data generated by the scanner 106. The one or more processors 502 may be any suitable processor-based resource. They may be, but are not limited to, a central processing unit (“CPU”), a hardware microprocessor, a multi-core processor, a single core processor, a field programmable gate array (“FPGA”), a controller, a microcontroller, an application specific integrated circuit (“ASIC”), a digital signal processor (“DSP”), or other similar processing device capable of executing any type of instructions, algorithms, or software for controlling the operation and performing the functions of the controller 402. In some embodiments, the one or more processors 502 may comprise a processor chipset including, for example and without limitation, one or more co-processors.

The memory 504 may be a single memory device or one or more memory devices at one or more memory locations that may include, without limitation, one or more of a random-access memory (“RAM”), a memory buffer, a hard drive, a database, an erasable programmable read only memory (“EPROM”), an electrically erasable programmable read only memory (“EEPROM”), a read only memory (“ROM”), a flash memory, hard disk, various layers of memory hierarchy, or any other non-transitory computer readable medium. The memory 504 may be on-chip or off-chip depending on the implementation of the one or more processors 502. The memory 504 may be used to store any type of instructions 506 and data associated with algorithms, processes, or operations for controlling the general functions and operations of the shredder 102, the conveyor 104, the scanner 106, or combinations thereof.

With reference, again, to FIG. 4, data may be acquired and processed on controller 402, or data may be transmitted from the controller 402 to a remote location for use and/or analysis, or some combination thereof. As used herein and in this context, “remote” means outside the physical presence of the controller 402. Conversely, “local” means in the physical presence of the controller 402. Such remote locations may include, without limitation, a central monitoring in another location or facility, or in a computing cloud located in another facility. Those skilled in the art having the benefit of this disclosure may appreciate still other variations on this theme.

The controller 402 may be in communication with at least one of the shredder 102, the conveyor 104, the scanner 106, and an image parser 404. In some embodiments, the image parser 404 analyses data provided by the scanner 106. The image parser 404 may implement an artificial intelligence (AI) or other machine learning model to perform the analysis of the data from the scanner 106. For example, the machine learning model may be trained using a training data set. The training data set may include a collection of images corresponding to known unfit portions of shred objects. The model may be trained to identify the images from the training data set as unshreddable. Once trained, the model may be able to identify a portion of a shred object unfit for shredding based on the training applied from the training data set. In some embodiments, the image parser 404 may be trained to identify a container. Containers may carry explosive, corrosive, radioactive, or otherwise undesirable contents that may be spilled or activated during the shredding process. This may cause a downtime of the shredder 102 resulting in a loss of efficiency, cost to repair, danger to an operator, or the like.

The image parser 404 may be trained to identify a high-density portion of the shred object. The shredder 102 may have a capacity to process a range of materials having a range of densities, a density above a limit may present a risk of damage, stoppage, or accelerated wear to the shredder 102. The risk may be pre-determined or may be determined dynamically. The image parser 404 may identify a portion of the shred object 108 having a density above the limit as unfit for shredding. While the example of a container geometry and a high-density are used, other objects may be undesirable for shredding based on other characteristics. The image parser 404 may be trained to identify one or more objects and/or one or more portions of a shred object as unfit based on other criteria. The image parser 404 may provide an indication of a confidence level corresponding to the indication of the unfit portion of the shred object 108.

Identification of the unfit portion of the shred object by the image parser 404 may be communicated from the image parser 404 to the controller 402. In response to communication from the image parser 404 identifying the unfit portion, the controller 402 may implement one or more actions or processes. For example, the controller 402 may slow, stop, and/or reverse at least one of the conveyor 104 or the shredder 102. In some embodiments, the image parser 404 is in direct communication with the scanner 106 to receive data from the scanner 106 corresponding to the shred object 108. For example, the scanner 106 may communicate the image data to the image parser 404 for analysis and generation of any resulting indication corresponding to a portion of the shred object 108 as unfit for shredding. The image parser 404 may then communicate the indication of the unfit portion to the controller 402.

In some embodiments, the controller 402 is in communication with the shredder 102 to control an operating state of the shredder 102. For example, the controller 402 may provide communication to the shredder 102 to start and/or stop operation of the shredder 102 in response to the image parser 404 providing an indication of the unfit portion of the shred object to the controller 402. Communication from the controller 402 to the shredder 102 may select and/or modify an operating speed of the shredder 102. For example, the controller 402 may send communication to the shredder 102 to stop an operation of the shredder 102 in response to detection of the unfit portion or may send communication to the shredder 102 to restart an operation of the shredder 102 in response to determination that the unfit portion has been removed or that the shred object is otherwise determined to be fit for shredding. Other operation conditions of the shredder 102 may be affected by communication from the controller 402.

In some embodiments, the controller 402 is in communication with the conveyor 104. For example, the controller 402 may provide communication to the conveyor 104 to set a conveyance speed of the conveyor 104. The controller 402 may control a conveyance speed of the conveyor 104 in response to an indication of the unfit portion of the shred object 108 on the conveyor 104. For example, the controller 402 may provide communication to the conveyor 104 to increase a conveyance speed of the conveyor 104, slow a conveyance speed of the conveyor 104, stop the conveyor 104, start the conveyor 104, and/or change a conveyance direction of the conveyor 104.

Communication to other components, such as a removal tool, may also be generated and provided by the controller 402. For example, the controller 402 may provide communication to a component of the conveyor 104 or removal tool to remove at least the unfit portion of the shred object 108 from the conveyor 104. The controller 402 may provide communication to a component of the apparatus 400 to manipulate the shred object 108 on the conveyor 104. The shred object 108 may be manipulated to scan the shred object 108, remove the shred object 108, or the like.

In some embodiments, the controller 402 may apply a pre-processing or other image data processing prior to communication of the image data to the image parser 404. For example, the controller 402 may add and/or remove data corresponding to a metadata for the image, duplicate image data, adjustment of image data with poor resolution or clarity, may order image data for parsing by the image parser 404, or the like. In some embodiments, the controller 402 may provide communication to the scanner 106 to send the image data to the image parser 404.

In response to the image parser 404 implementing an artificial intelligence or other machine learning model-trained element and identifying a container or other unshreddable item or characteristic within the shred object, the controller 402 may communicate with the image parser 404 to receive the indication of the unfit portion of the shred object. In response to the indication of the unfit portion, the controller 402 may communicate with one or more of the shredder 102, the conveyor 104, and/or the scanner 106. For example, the controller 402 may trigger a confirmation scan of the region of the shred object containing the unfit portion. The controller 402 may cause the conveyor to slow, stop, or reverse to facilitate further scanning or removal of the unfit portion. The controller 402 may slow, stop, or reverse the shredder 102 to reduce a likelihood of damage to the shredder 102.

In some embodiments, the controller 402 may generate a communication corresponding to the indication of the unfit portion. For example, the communication may include a trigger, message, signal, or the like for an alarm, alert, notification, etc. For example, the controller 402 may provide the indication of the unfit portion of the shred object 108 to a display, an alarm or other sound generation device, a flasher or other light generation device, or the like. The device may be local or remote relative to one or more of the shredder 102, the conveyor 104, the scanner 106, the image parser 404, the controller 402, or some other component of the apparatus 400. Examples of such a device may include a terminal, mobile device, or other device capable of communicating a state of the shred process or relevant component.

The communication from the controller 402 to the terminal or other device (not shown) may include a request for input on how to proceed. The communication from the controller 402 may generate and/or communicate a request for a review and/or confirmation of a proposed action or selection from a list of suggested or possible actions. The communication from the controller 402 may be a notification of the indication of the unfit portion with the action that has been taken, will be taken, and/or can be taken in response to the indication. In some embodiments, the controller 402 may implement an automated action in response to the indication of the unfit portion. For example, the controller 402 may implement an automated action to provide a stop command to the conveyor 104. The controller 402 may stop the conveyor 104 and provide a notification of the automated action with a request for confirmation and/or a request for a subsequent action such as a removal action, a reversal of the conveyor 104, a stoppage of the shredder 102, or the like.

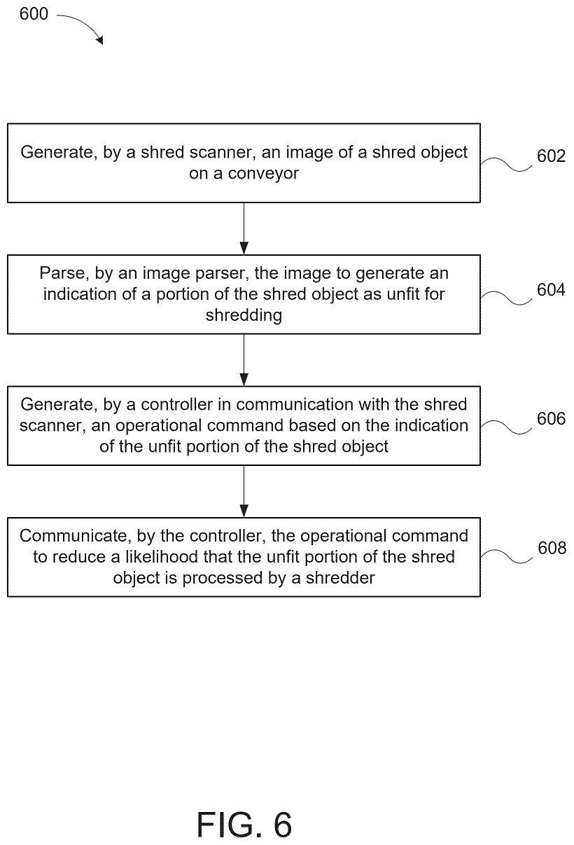

FIG. 6 is a flowchart depicting a method 500 for controlling a shredding process, according to one or more examples of the disclosure. In some embodiments, the method 500 includes, at block 602, generating, by a scanner, an image of a shred object on a conveyor. As described with respect to FIG. 1, the scanner 106 may be positioned relative to the conveyor 104 to image the shred object 108 positioned on the conveyor 104. The shred object 108 may be moving (e.g., in the process of being conveyed) or stationary during image acquisition. The scanner 106 may generate an image via x-ray or other detection. In some embodiments, the scanner 106 utilizes one or more imaging technologies or combination of imaging technologies (e.g., x-ray, optical, magnetic, infrared, etc.). The image may be generated by a single scan, a series of scans, and/or a composite of scans.

The method 600 may also include, at block 604, parsing, by an image parser, the image to generate an indication of a portion of the shred object as unfit for shredding. The image parser (e.g., image parser 404 of FIG. 4) may implement a machine learning model trained with a sample training data set of images of objects unfit for shredding. The model may be implemented to identify containers, high-density regions, combustibles, or the like which may damage a shredder or other component or otherwise create an unsafe situation. The determination may be based on geometry, density, reflectivity, absorption, or another characteristic of the portion of the shred object.

The image parser may generate an indication of the portion of the shred object as unfit in a binary format (unfit/fit). The indication may be based on a characteristic exceeding or otherwise outside of a capacity of the shredder or may be based on an independent threshold set manually or determined dynamically. In some embodiments, the image parser may provide a confidence determination associated with the indication. The confidence determination may describe a degree of confidence in the determination that the corresponding portion is unfit (and/or fit) for shredding.

The method 600 may also include, at block 606, generating, by a controller in communication with the image parser, an operational command based on the indication of the unfit portion of the shred object. The controller may generate, as at least a part of the operational command or separate from the operation command, a removal command to remove or otherwise transport the unfit portion of the shred object from the conveyor. The removal command may be communicated to a removal tool and/or other component to facilitate removal of the unfit portion.

The method 600 may also include, at block 608, communicating, by the controller, the operational command to reduce a likelihood that the unfit portion of the shred object is processed by a shredder. The operational command may affect an operation of the conveyor, shredder, scanner, or other component.

Examples in the present disclosure may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A system comprising:
a shredder;
a conveyor positioned relative to the shredder to transport a shred object to the shredder;
a scanner positioned upstream of the shredder relative to the conveyor to generate an image of the shred object on the conveyor;
an image parser to generate an indication of a portion of the shred object as unfit for shredding by parsing the image of the shred object based on an identifier model trained on a sample training data set; and
a controller in communication with:
the image parser to receive the indication from the image parser; and
at least one of the shredder, the conveyor, or a removal tool to provide, in response to the indication of the unfit portion of the shred object, an operational command to the at least one of the shredder, the conveyor, or a removal tool to reduce a likelihood that the unfit portion of the shred object is processed by the shredder.

2. The system of claim 1, wherein the shredder is equipped to process the shred object by at least one of mechanically shredding the shred object or exposing the shred object to a laser or a chemical.

3. The system of claim 1, the conveyor comprises:
a scan conveyor portion corresponding to the scanner to convey the shred object relative to the scanner; and
a shred conveyor portion of the conveyor corresponding to the shredder to convey the shred object relative to the shredder independent of the scanner conveyor portion of the conveyor.

4. The system of claim 1, wherein the controller provides a removal command to remove the unfit portion from the conveyor.

5. The system of claim 1, wherein the image parser detects the unfit portion based on an identification of a geometry corresponding to a container.

6. The system of claim 1, wherein the image parser detects the unfit portion based on an identification of a density of the unfit portion exceeding a capacity of the shredder.

7. The system of claim 1, wherein the scanner generates the image of the shred object by directing x-ray energy to the shred object and detecting the x-ray energy passed through the shred object.

8. A method for controlling a shredding process, the method comprising:
generating, by a scanner, an image of a shred object on a conveyor;
parsing, by an image parser, the image to generate an indication of a portion of the shred object as unfit for shredding;
generating, by a controller in communication with the image parser, an operational command based on the indication of the unfit portion of the shred object; and
communicating, by the controller, the operational command to reduce a likelihood that the unfit portion of the shred object is processed by a shredder.

9. The method of claim 8, further comprising:
transporting the shred object on a scan conveyor portion of the conveyor to pass the shred object proximate the scanner; and
delivering the shred object from the scan conveyor portion to a shred conveyor portion of the conveyor to convey the shred object to the shredder.

10. The method of claim 8, further comprising generating, by the controller, a removal command based on the indication of the unfit portion of the shred object to remove at least the unfit portion from the conveyor.

11. The method of claim 8, further comprising detecting, by the image parser, the unfit portion based on an identification of a geometry corresponding to a container.

12. The method of claim 8, further comprising detecting, by the image parser, the unfit portion based on an identification of a density of the unfit portion exceeding a capacity of the shredder.

13. The method of claim 8, further comprising generating, by the scanner, the image of the shred object by directing x-ray energy to the shred object and detecting the x-ray energy passed through the shred object.

14. The method of claim 8, further comprising determining, by the image parser, a confidence level of the indication of the unfit portion.

15. An apparatus for controlling a shredding process, the apparatus comprising:
a processor;
memory in communication with the processor; and
instructions stored in the memory, the instructions executable by the processor to:
generate, by a scanner, an image of a shred object on a conveyor;
parse, by an image parser, the image to generate an indication of a portion of the shred object as unfit for shredding;
generate, by a controller in communication with the image parser, an operational command based on the indication of the unfit portion of the shred object; and
communicate, by the controller, the operational command to reduce a likelihood that the unfit portion of the shred object is processed by a shredder.

16. The apparatus of claim 15, wherein the instructions are further executable by the processor to:
transport the shred object on a scan conveyor portion of the conveyor to pass the shred object proximate the scanner; and
deliver the shred object from the scan conveyor portion to a shred conveyor portion of the conveyor to convey the shred object to the shredder.

17. The apparatus of claim 15, wherein the instructions are further executable by the processor to generate, by the controller, a removal command based on the indication of the unfit portion of the shred object to remove at least the unfit portion from the conveyor.

18. The apparatus of claim 15, wherein the instructions are further executable by the processor to detect, by the image parser, the unfit portion based on an identification of a geometry corresponding to a container.

19. The apparatus of claim 15, wherein the instructions are further executable by the processor to detect, by the image parser, the unfit portion based on an identification of a density of the unfit portion exceeding a capacity of the shredder.

20. The apparatus of claim 15, wherein the instructions are further executable by the processor to generate, by the scanner, the image of the shred object by directing x-ray energy to the shred object and detecting the x-ray energy passed through the shred object.
